(19) United States
(12) Patent Application Publication
(10) Pub. No.: US 2019/0065315 A1
(43) Pub. Date: Feb. 28, 2019

(54) IDENTIFYING ENCODED DATA SLICES FOR REBUILDING

(71) Applicant: International Business Machines Corporation, Armonk, NY (US)

(72) Inventors: Thomas F. Shirley, JR., Wauwatosa, WI (US); Gary W. Grube, Barrington Hills, IL (US); Bart R. Cilfone, Marina del Rey, CA (US); Ravi V. Khadiwala, Bartlett, IL (US); Greg R. Dhuse, Chicago, IL (US); Thomas D. Cocagne, Elk Grove Village, IL (US); Michael C. Storm, Palo Alto, CA (US); Yogesh R. Vedpathak, Chicago, IL (US); Wesley B. Leggette, Chicago, IL (US); Jason K. Resch, Chicago, IL (US); Andrew D. Baptist, Mt. Pleasant, WI (US); Ilya Volvovski, Chicago, IL (US)

(21) Appl. No.: 16/171,585

(22) Filed: Oct. 26, 2018

Related U.S. Application Data
(63) Continuation-in-part of application No. 15/705,782, filed on Sep. 15, 2017.
Application No. 15/705,782 is a continuation of application No. 14/570,366, filed on Dec. 15, 2014, now Pat. No. 9,778,987.
(60) Provisional application No. 61/934,036, filed on Jan. 31, 2014.

(51) Int. Cl. G06F 11/10; G06F 21/62; H04L 29/08; G06F 3/06; H04L 29/06

(52) U.S. Cl. CPC G06F 11/1092; G06F 21/6218; G06F 2211/1028; G06F 3/06; H04L 63/20; H04L 67/1097

(57) ABSTRACT

A method for identifying encoded data slices for rebuilding includes determining, by a computing device of a dispersed storage network (DSN), a partial scanning approach based on an event, where the event is one of a plurality of possible events. When the event is a memory device issue, the method further includes selecting a first partial scanning approach that includes: sending a scan memory device request to the storage unit to scan the memory device for encoded data slices affected by the memory device issue, receiving a scan memory device response from the storage unit, and identifying the encoded data slices indicated in the scan memory device response for rebuilding.

### CROSS-REFERENCE TO RELATED APPLICATIONS

This application claims priority pursuant to 35 U.S.C. § 120 as a continuation-in-part of U.S. Utility application Ser. No. 15/705,782, entitled “WRITING ENCODED DATA SLICES IN A DISPERSED STORAGE NETWORK,” filed Sep. 15, 2017, which claims priority pursuant to claims priority pursuant to 35 U.S.C. § 120 as a continuation of U.S. Utility application Ser. No. 14/570,366, entitled “WRITING ENCODED DATA SLICES IN A DISPERSED STORAGE NETWORK,” filed Dec. 15, 2014, issued as U.S. Pat. No. 9,778,987 on Oct. 3, 2017, which claims priority pursuant to 35 U.S.C. § 119(e) to U.S. Provisional Application No. 61/934,036, entitled “UTILIZING STORAGE SLOTS IN A DISPERSED STORAGE NETWORK,” filed Jan. 31, 2014, all of which are hereby incorporated herein by reference in their entirety and made part of the present U.S. Utility patent application for all purposes.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

### Technical Field of the Invention

This invention relates generally to computer networks and more particularly to dispersing error encoded data.

### Description of Related Art

Computing devices are known to communicate data, process data, and/or store data. Such computing devices range from wireless smart phones, laptops, tablets, personal computers (PC), work stations, and video game devices, to data centers that support millions of web searches, stock trades, or on-line purchases every day. In general, a computing device includes a central processing unit (CPU), a memory system, user input/output interfaces, peripheral device interfaces, and an interconnecting bus structure.

As is further known, a computer may effectively extend its CPU by using “cloud computing” to perform one or more computing functions (e.g., a service, an application, an algorithm, an arithmetic logic function, etc.) on behalf of the computer. Further, for large services, applications, and/or functions, cloud computing may be performed by multiple cloud computing resources in a distributed manner to improve the response time for completion of the service, application, and/or function. For example, Hadoop is an open source software framework that supports distributed applications enabling application execution by thousands of computers.

In addition to cloud computing, a computer may use “cloud storage” as part of its memory system. As is known, cloud storage enables a user, via its computer, to store files, applications, etc. on an Internet storage system. The Internet storage system may include a RAID (redundant array of independent disks) system and/or a dispersed storage system that uses an error correction scheme to encode data for storage.

It is further known that a full scan of a set of storage units to find encoded data slices in need of rebuilding is time consuming and resource consuming.

### BRIEF DESCRIPTION OF THE SEVERAL VIEWS OF THE DRAWING(S)

FIG. 1 is a schematic block diagram of an embodiment of a dispersed or distributed storage network (DSN) in accordance with the present invention;

FIG. 2 is a schematic block diagram of an embodiment of a computing core in accordance with the present invention;

FIG. 3 is a schematic block diagram of an example of dispersed storage error encoding of data in accordance with the present invention;

FIG. 4 is a schematic block diagram of a generic example of an error encoding function in accordance with the present invention;

FIG. 5 is a schematic block diagram of a specific example of an error encoding function in accordance with the present invention;

FIG. 6 is a schematic block diagram of an example of a slice name of an encoded data slice (EDS) in accordance with the present invention;

FIG. 7 is a schematic block diagram of an example of dispersed storage error decoding of data in accordance with the present invention;

FIG. 8 is a schematic block diagram of a generic example of an error decoding function in accordance with the present invention;

FIGS. 9A-9D are schematic block diagrams of an embodiment of a dispersed storage network (DSN) illustrating an example of storing data in accordance with the present invention;

FIG. 10 is a flowchart illustrating an example of storing data in accordance with the present invention;

FIG. 11 is a schematic block diagram of another embodiment of a dispersed storage network (DSN) in accordance with the present invention; and

FIG. 12 is a logic diagram of an example of a method of identifying encoded data slices for rebuilding in accordance with the present invention.

### DETAILED DESCRIPTION OF THE INVENTION

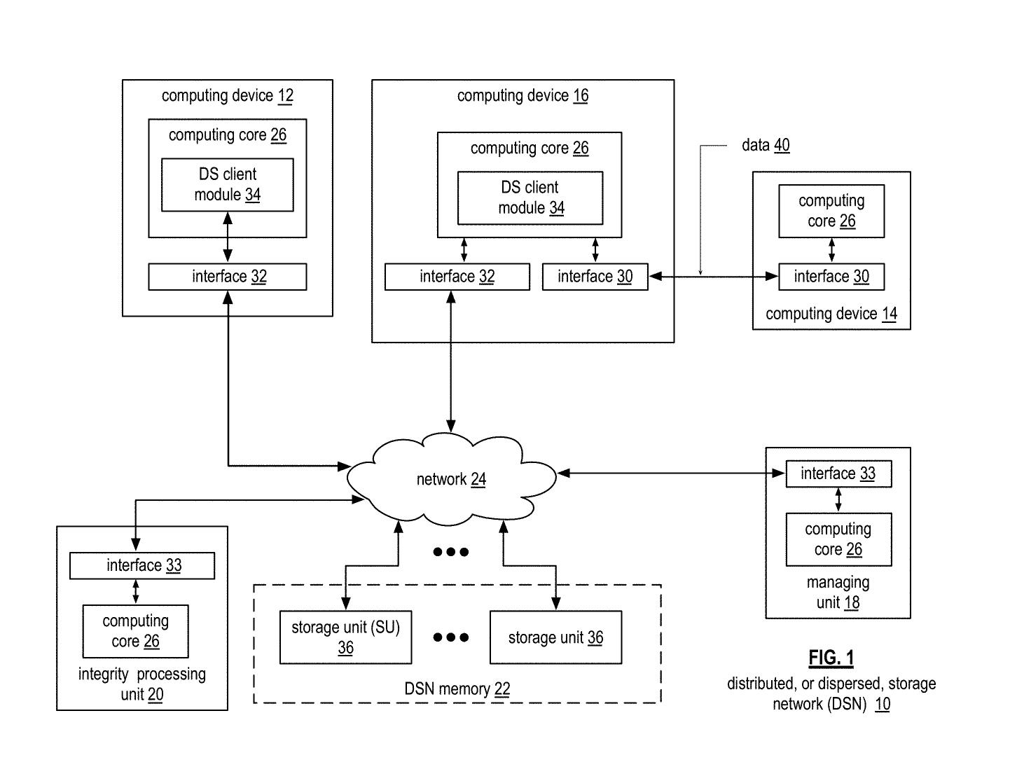

FIG. 1 is a schematic block diagram of an embodiment of a dispersed, or distributed, storage network (DSN) 10 that includes a plurality of computing devices 12-16, a managing unit 18, an integrity processing unit 20, and a DSN memory 22. The components of the DSN 10 are coupled to a network 24, which may include one or more wireless and/or wire lined communication systems; one or more non-public intranet systems and/or public internet systems; and/or one or more local area networks (LAN) and/or wide area networks (WAN).

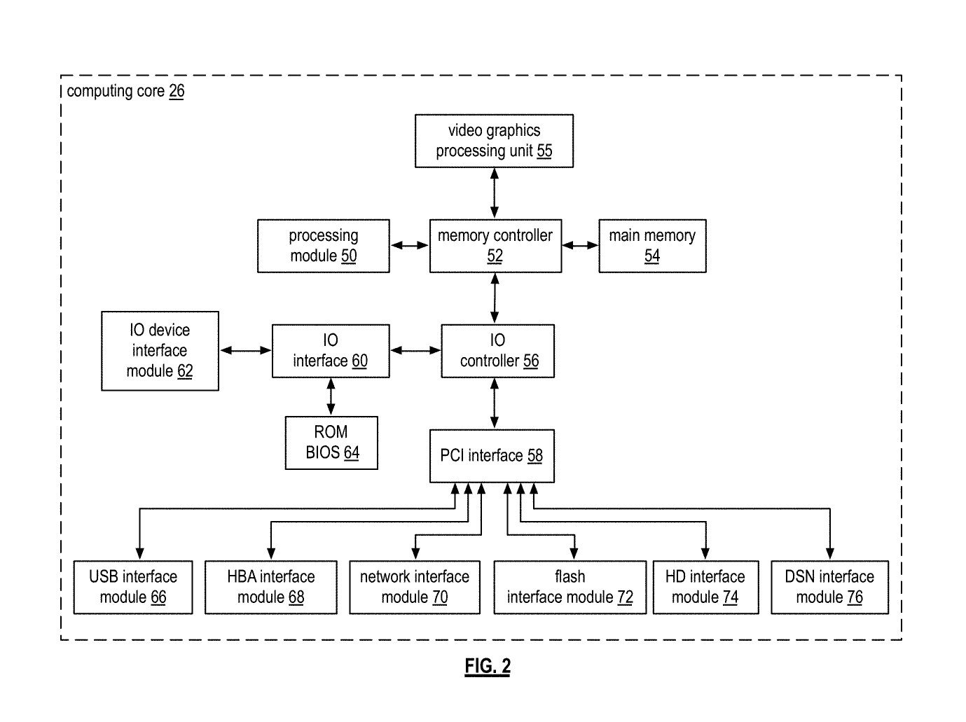

The DSN memory 22 includes a plurality of storage units 36 that may be located at geographically different sites (e.g., one in Chicago, one in Milwaukee, etc.), at a common site, or a combination thereof. For example, if the DSN memory 22 includes eight storage units 36, each storage unit is located at a different site. As another example, if the DSN memory 22 includes eight storage units 36, all eight storage units are located at the same site. As yet another example, if the DSN memory 22 includes eight storage units 36, a first pair of storage units are at a first common site, a second pair of storage units are at a second common site, a third pair of storage units are at a third common site, and a fourth pair of storage units are at a fourth common site. Note that a DSN memory 22 may include more or less than eight storage units 36. Further note that each storage unit 36 includes a computing core (as shown in FIG. 2, or components thereof) and a plurality of memory devices for storing dispersed error encoded data.

Each of the computing devices 12-16, the managing unit 18, and the integrity processing unit 20 include a computing core 26, which includes network interfaces 30-33. Computing devices 12-16 may each be a portable computing device and/or a fixed computing device. A portable computing device may be a social networking device, a gaming device, a cell phone, a smart phone, a digital assistant, a digital music player, a digital video player, a laptop computer, a handheld computer, a tablet, a video game controller, and/or any other portable device that includes a computing core. A fixed computing device may be a computer (PC), a computer server, a cable set-top box, a satellite receiver, a television set, a printer, a fax machine, home entertainment equipment, a video game console, and/or any type of home or office computing equipment. Note that each of the managing unit 18 and the integrity processing unit 20 may be separate computing devices, may be a common computing device, and/or may be integrated into one or more of the computing devices 12-16 and/or into one or more of the storage units 36.

Each interface 30, 32, and 33 includes software and hardware to support one or more communication links via the network 24 indirectly and/or directly. For example, interface 30 supports a communication link (e.g., wired, wireless, direct, via a LAN, via the network 24, etc.) between computing devices 14 and 16. As another example, interface 32 supports communication links (e.g., a wired connection, a wireless connection, a LAN connection, and/or any other type of connection to/from the network 24) between computing devices 12 & 16 and the DSN memory 22. As yet another example, interface 33 supports a communication link for each of the managing unit 18 and the integrity processing unit 20 to the network 24.

Computing devices 12 and 16 include a dispersed storage (DS) client module 34, which enables the computing device to dispersed storage error encode and decode data as subsequently described with reference to one or more of FIGS. 3-8. In this example embodiment, computing device 16 functions as a dispersed storage processing agent for computing device 14. In this role, computing device 16 dispersed storage error encodes and decodes data on behalf of computing device 14. With the use of dispersed storage error encoding and decoding, the DSN 10 is tolerant of a significant number of storage unit failures (the number of failures is based on parameters of the dispersed storage error encoding function) without loss of data and without the need for a redundant or backup copies of the data. Further, the DSN 10 stores data for an indefinite period of time without data loss and in a secure manner (e.g., the system is very resistant to unauthorized attempts at accessing the data).

In operation, the managing unit 18 performs DS management services. For example, the managing unit 18 establishes distributed data storage parameters (e.g., vault creation, distributed storage parameters, security parameters, billing information, user profile information, etc.) for computing devices 12-14 individually or as part of a group of user devices. As a specific example, the managing unit 18 coordinates creation of a vault (e.g., a virtual memory block associated with a portion of an overall namespace of the DSN) within the DSN memory 22 for a user device, a group of devices, or for public access and establishes per vault dispersed storage (DS) error encoding parameters for a vault. The managing unit 18 facilitates storage of DS error encoding parameters for each vault by updating registry information of the DSN 10, where the registry information may be stored in the DSN memory 22, a computing device 12-16, the managing unit 18, and/or the integrity processing unit 20.

The DSN managing unit 18 creates and stores user profile information (e.g., an access control list (ACL)) in local memory and/or within memory of the DSN memory 22. The user profile information includes authentication information, permissions, and/or the security parameters. The security parameters may include encryption/decryption scheme, one or more encryption keys, key generation scheme, and/or data encoding/decoding scheme.

The DSN managing unit 18 creates billing information for a particular user, a user group, a vault access, public vault access, etc. For instance, the DSN managing unit 18 tracks the number of times a user accesses a non-public vault and/or public vaults, which can be used to generate a per-access billing information. In another instance, the DSN managing unit 18 tracks the amount of data stored and/or retrieved by a user device and/or a user group, which can be used to generate a per-data-amount billing information.

As another example, the managing unit 18 performs network operations, network administration, and/or network maintenance. Network operations includes authenticating user data allocation requests (e.g., read and/or write requests), managing creation of vaults, establishing authentication credentials for user devices, adding/deleting components (e.g., user devices, storage units, and/or computing devices with a DS client module 34) to/from the DSN 10, and/or establishing authentication credentials for the storage units 36. Network administration includes monitoring devices and/or units for failures, maintaining vault information, determining device and/or unit activation status, determining device and/or unit loading, and/or determining any other system level operation that affects the performance level of the DSN 10. Network maintenance includes facilitating replacing, upgrading, repairing, and/or expanding a device and/or unit of the DSN 10.

The integrity processing unit 20 performs rebuilding of ‘bad’ or missing encoded data slices. At a high level, the integrity processing unit 20 performs rebuilding by periodically attempting to retrieve/list encoded data slices, and/or slice names of the encoded data slices, from the DSN memory 22. For retrieved encoded slices, they are checked for errors due to data corruption, outdated version, etc. If a slice includes an error, it is flagged as a ‘bad’ slice. For encoded data slices that were not received and/or not listed, they are flagged as missing slices. Bad and/or missing slices are subsequently rebuilt using other retrieved encoded data slices that are deemed to be good slices to produce rebuilt slices. The rebuilt slices are stored in the DSN memory 22.

FIG. 2 is a schematic block diagram of an embodiment of a computing core 26 that includes a processing module 50, a memory controller 52, main memory 54, a video graphics processing unit 55, an input/output (IO) controller 56, a peripheral component interconnect (PCI) interface 58, an 10 interface module 60, at least one IO device interface module 62, a read only memory (ROM) basic input output system (BIOS) 64, and one or more memory interface modules. The one or more memory interface module(s) includes one or more of a universal serial bus (USB) interface module 66, a host bus adapter (HBA) interface module 68, a network interface module 70, a flash interface module 72, a hard drive interface module 74, and a DSN interface module 76.

The DSN interface module 76 functions to mimic a conventional operating system (OS) file system interface (e.g., network file system (NFS), flash file system (FFS), disk file system (DFS), file transfer protocol (FTP), web-based distributed authoring and versioning (WebDAV), etc.) and/or a block memory interface (e.g., small computer system interface (SCSI), internet small computer system interface (iSCSI), etc.). The DSN interface module 76 and/or the network interface module 70 may function as one or more of the interface 30-33 of FIG. 1. Note that the 10 device interface module 62 and/or the memory interface modules 66-76 may be collectively or individually referred to as IO ports.

FIG. 3 is a schematic block diagram of an example of dispersed storage error encoding of data. When a computing device 12 or 16 has data to store it disperse storage error encodes the data in accordance with a dispersed storage error encoding process based on dispersed storage error encoding parameters. The dispersed storage error encoding parameters include an encoding function (e.g., information dispersal algorithm, Reed-Solomon, Cauchy Reed-Solomon, systematic encoding, non-systematic encoding, on-line codes, etc.), a data segmenting protocol (e.g., data segment size, fixed, variable, etc.), and per data segment encoding values. The per data segment encoding values include a total, or pillar width, number (T) of encoded data slices per encoding of a data segment i.e., in a set of encoded data slices); a decode threshold number (D) of encoded data slices of a set of encoded data slices that are needed to recover the data segment; a read threshold number (R) of encoded data slices to indicate a number of encoded data slices per set to be read from storage for decoding of the data segment; and/or a write threshold number (W) to indicate a number of encoded data slices per set that must be accurately stored before the encoded data segment is deemed to have been properly stored. The dispersed storage error encoding parameters may further include slicing information (e.g., the number of encoded data slices that will be created for each data segment) and/or slice security information (e.g., per encoded data slice encryption, compression, integrity checksum, etc.).

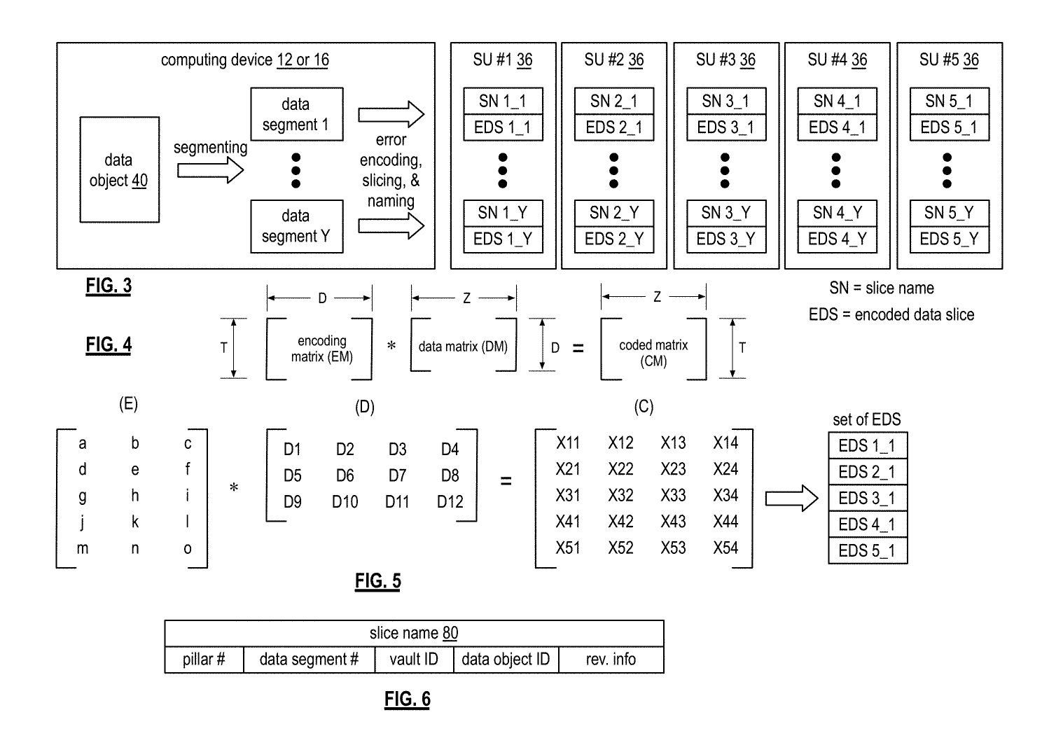

In the present example, Cauchy Reed-Solomon has been selected as the encoding function (a generic example is shown in FIG. 4 and a specific example is shown in FIG. 5); the data segmenting protocol is to divide the data object into fixed sized data segments; and the per data segment encoding values include: a pillar width of 5, a decode threshold of 3, a read threshold of 4, and a write threshold of 4. In accordance with the data segmenting protocol, the computing device 12 or 16 divides the data (e.g., a file (e.g., text, video, audio, etc.), a data object, or other data arrangement) into a plurality of fixed sized data segments (e.g., 1 through Y of a fixed size in range of Kilo-bytes to Tera-bytes or more). The number of data segments created is dependent of the size of the data and the data segmenting protocol.

The computing device 12 or 16 then disperse storage error encodes a data segment using the selected encoding function (e.g., Cauchy Reed-Solomon) to produce a set of encoded data slices. FIG. 4 illustrates a generic Cauchy Reed-Solomon encoding function, which includes an encoding matrix (EM), a data matrix (DM), and a coded matrix (CM). The size of the encoding matrix (EM) is dependent on the pillar width number (T) and the decode threshold number (D) of selected per data segment encoding values. To produce the data matrix (DM), the data segment is divided into a plurality of data blocks and the data blocks are arranged into D number of rows with Z data blocks per row. Note that Z is a function of the number of data blocks created from the data segment and the decode threshold number (D). The coded matrix is produced by matrix multiplying the data matrix by the encoding matrix.

FIG. 5 illustrates a specific example of Cauchy Reed-Solomon encoding with a pillar number (T) of five and decode threshold number of three. In this example, a first data segment is divided into twelve data blocks (D1-D12). The coded matrix includes five rows of coded data blocks, where the first row of X11-X14 corresponds to a first encoded data slice (EDS 1_1), the second row of X21-X24 corresponds to a second encoded data slice (EDS 2_1), the third row of X31-X34 corresponds to a third encoded data slice (EDS 3_1), the fourth row of X41-X44 corresponds to a fourth encoded data slice (EDS 4_1), and the fifth row of X51-X54 corresponds to a fifth encoded data slice (EDS 5_1). Note that the second number of the EDS designation corresponds to the data segment number.

Returning to the discussion of FIG. 3, the computing device also creates a slice name (SN) for each encoded data slice (EDS) in the set of encoded data slices. A typical format for a slice name 60 is shown in FIG. 6. As shown, the slice name (SN) 60 includes a pillar number of the encoded data slice (e.g., one of 1-T), a data segment number (e.g., one of 1-Y), a vault identifier (ID), a data object identifier (ID), and may further include revision level information of the encoded data slices. The slice name functions as, at least part of, a DSN address for the encoded data slice for storage and retrieval from the DSN memory 22.

As a result of encoding, the computing device 12 or 16 produces a plurality of sets of encoded data slices, which are provided with their respective slice names to the storage units for storage. As shown, the first set of encoded data slices includes EDS 1_1 through EDS 5_1 and the first set of slice names includes SN 1_1 through SN 5_1 and the last set of encoded data slices includes EDS 1_Y through EDS 5_Y and the last set of slice names includes SN 1_Y through SN 5_Y.

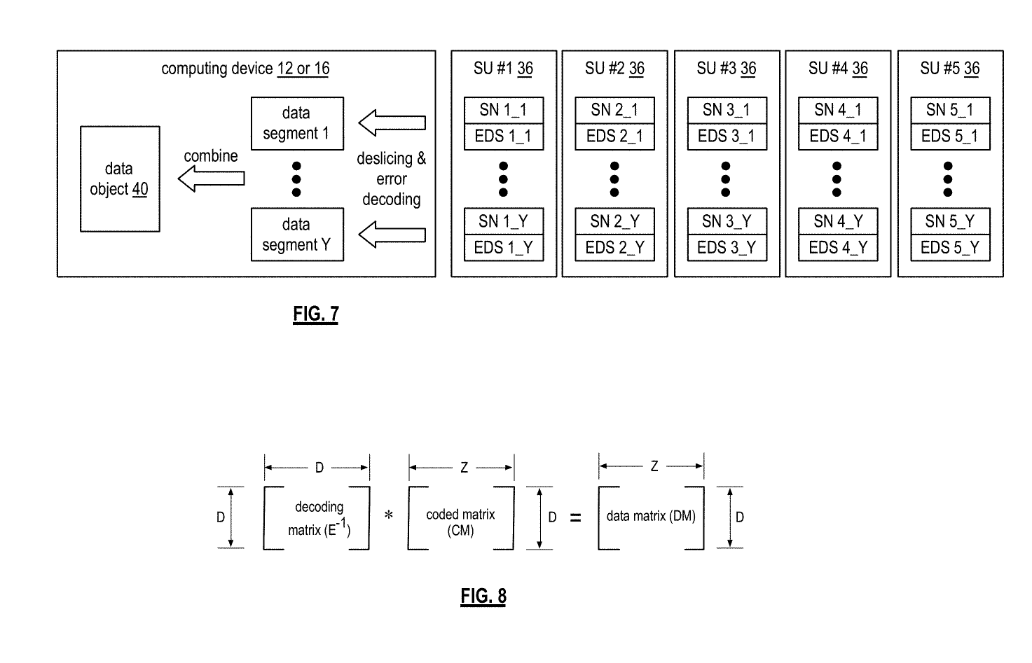

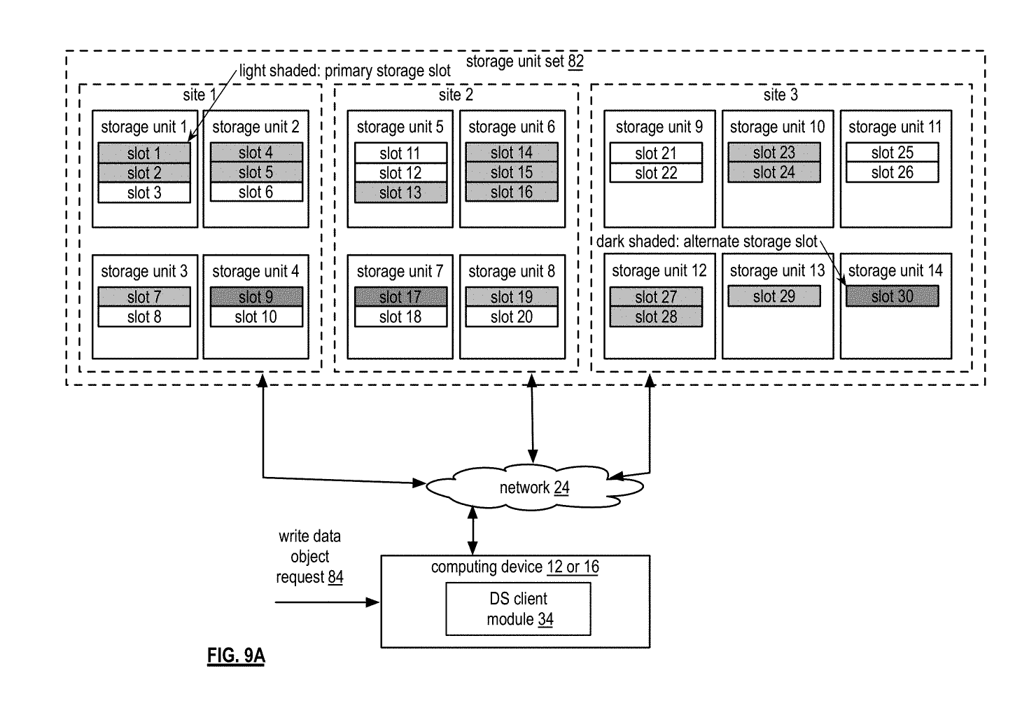

FIG. 7 is a schematic block diagram of an example of dispersed storage error decoding of a data object that was dispersed storage error encoded and stored in the example of FIG. 4. In this example, the computing device 12 or 16 retrieves from the storage units at least the decode threshold number of encoded data slices per data segment. As a specific example, the computing device retrieves a read threshold number of encoded data slices.

To recover a data segment from a decode threshold number of encoded data slices, the computing device uses a decoding function as shown in FIG. 8. As shown, the decoding function is essentially an inverse of the encoding function of FIG. 4. The coded matrix includes a decode threshold number of rows (e.g., three in this example) and the decoding matrix in an inversion of the encoding matrix that includes the corresponding rows of the coded matrix. For example, if the coded matrix includes rows 1, 2, and 4, the encoding matrix is reduced to rows 1, 2, and 4, and then inverted to produce the decoding matrix.

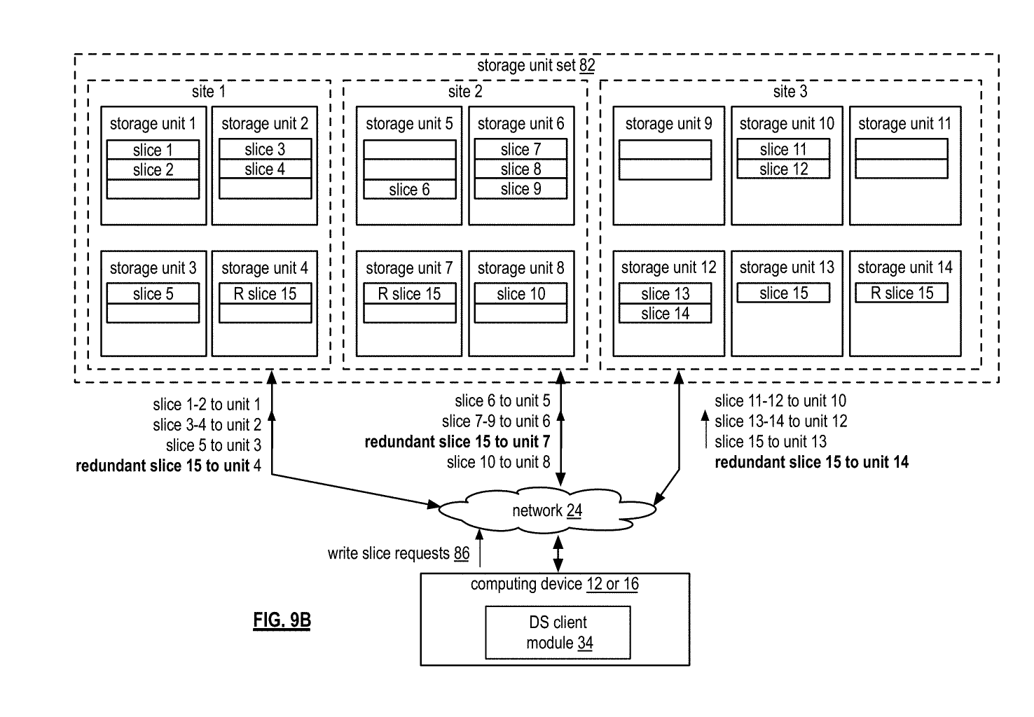

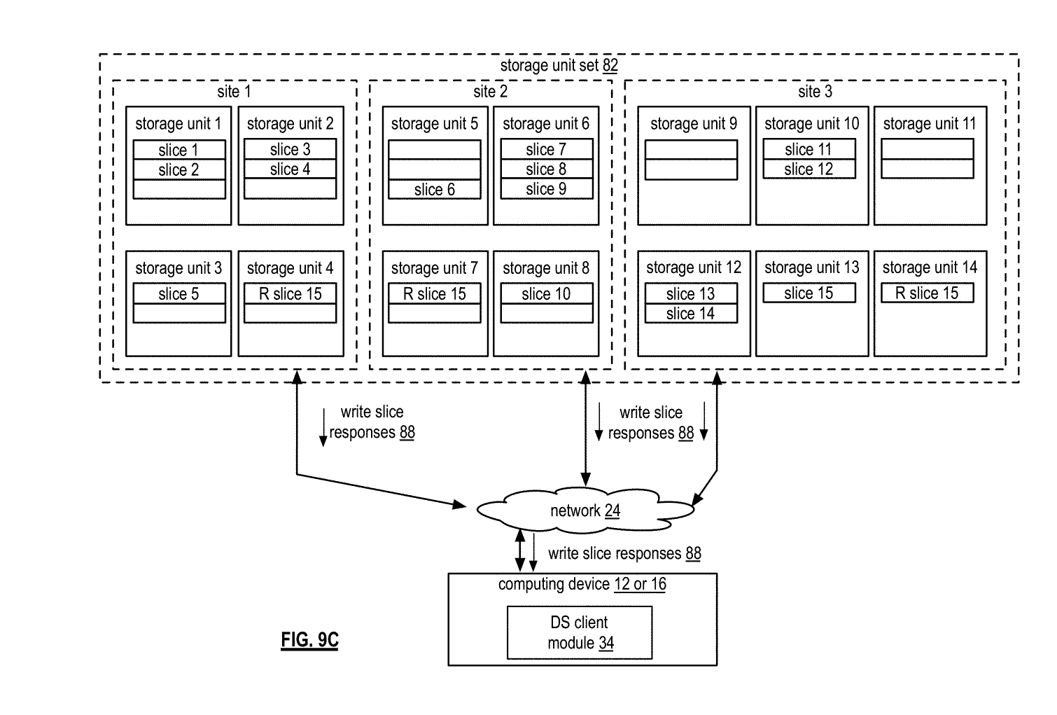

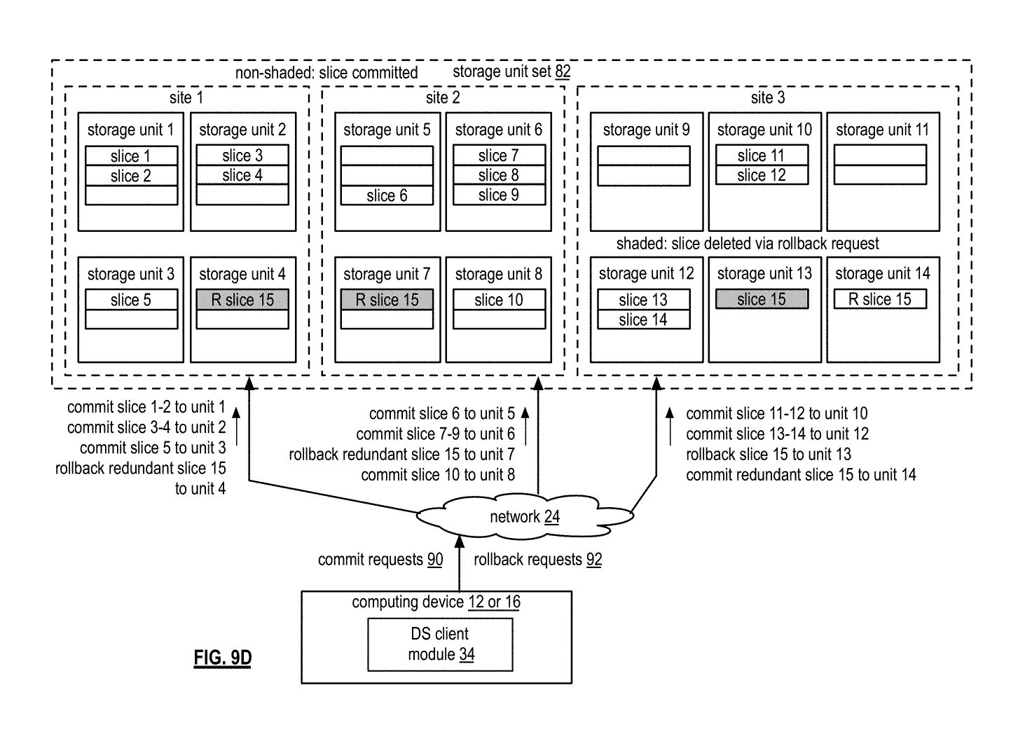

FIGS. 9A-9D are schematic block diagrams of an embodiment of a dispersed storage network (DSN) illustrating an example of storing data, where the DSN includes computing device 12 or 16, storage unit set 82, and network 24. Computing device 12 or 16 includes a dispersed storage (DS) client module 34, which enables the computing device to dispersed storage error encode and decode data. Storage unit set 82 includes a set of storage units 36, where one or more storage units are deployed at one or more sites. Each storage unit provides at least one storage slot of N storage slots. A storage slot includes at least one of a virtual storage location associated with physical memory of the storage. For example, the storage unit set 82 includes storage units 1-14 when 30 storage slots are provided and a varying number of storage slots are associated with each storage unit. Storage units 1-4 are deployed at site 1, storage units 5-8 are deployed at site 2, and storage units 9-14 are deployed at site 3.

The DSN functions to store data to the storage unit set 82 and to retrieve the stored data from the storage unit set 82. FIG. 9 illustrates initial steps of an example of operation of the storing of the data to the storage unit set 82, where the computing device 12 or 16 receives a write data object request 84 from a requesting entity. The write data object request 84 includes one or more of a data object for storage in the DSN, a data identifier (ID) of the data object, an ID of the requesting entity, and a desired performance level indicator. Having received the write data object request 84, the computing device 12 or 16 obtains dispersal parameters. The dispersal parameters includes one or more of a number of storage slots N, an information dispersal algorithm (IDA) width number, a write threshold number, a read threshold number, and a decode threshold number, where a decode threshold number is a minimum number of required encoded data slices of the set of encoded data slices to recover a data segment and where the data segment is dispersed storage error encoded to produce a set of encoded data slices that includes an IDA width number of encoded data slices. The obtaining includes at least one of retrieving a portion of system registry information, utilizing a predetermination, determining based on the desired performance level indicator, and accessing a list based on the requesting entity ID.

Having obtained the dispersal parameters, computing device 12 or 16 selects a set of primary storage slots of N storage slots associated with the storage unit set, where the set of storage slots includes at least a decode threshold number of storage slots and at most an IDA width number of storage slots. The selecting may be based on one or more of storage unit availability information, site availability information, system topology information, a system loading level, a system loading goal level, a data storage availability goal, a data retrieval reliability goal, and a site selection scheme. As a specific example, computing device 12 or 16 selects the IDA width number of storage slots out of the N storage slots. As such, the computing device 12 or 16 selects one permutation out of a number of permutations expressed by a formula: number of permutations of the selecting of the IDA width number of storage slots=N choose IDA width. For instance, the number of permutations of selecting the IDA width number of storage slots=30 choose 15=155 million permutations, when N=30 and the IDA width=15.

Storage of data within the storage unit set can tolerate a number of storage slot failures and/or unavailability without affecting data storage availability and data retrieval reliability in accordance with a formula: number of storage slot failures tolerated=N−IDA width=30−15=15. As such, the storage of data within the storage unit set 82 can tolerate 15 storage slot failures.

The computing device 12 or 16 may select the IDA width number of storage slots in accordance with the site selection scheme to improve the data retrieval reliability. For example, the computing device 12 or 16 selects storage slots at each site of the one or more sites such that at least a decode threshold number of encoded data slices are available from available storage slots at a minimum desired number of sites. As a specific example, computing device 12 or 16 selects storage slots associated with available and better-than-average performing storage units such that the decode threshold number of encoded data slices are available from any two operational sites when one of three total sites is unavailable. For instance, computing device 12 or 16 selects 5 storage slots at each of the 3 sites when the IDA width is 15 and the decode threshold is 10 in accordance with an even distribution selection scheme.

Having selected the set of primary storage slots, computing device 12 or 16 encodes the data object using a dispersed storage error encoding function and in accordance with the dispersal parameters to produce a plurality of sets of encoded data slices. For example, the computing device 12 or 16 encodes a first data segment of a plurality of data segments of the data object to produce a first set of encoded data slices, where the first set of encoded data slices includes the IDA width number of slices and the first data segment may be recovered when at least any decode threshold number of encoded data slices of the set of encoded data slices is retrievable.

Having encoded the data object, computing device 12 or 16 identifies an encoded data slice of a set of encoded data slices for a redundant write operation to produce an identified encoded data slice. The identifying may be based on one or more of a performance level of an associated storage unit, a storage unit performance goal level, a network loading level, a network loading level goal. For example, computing device 12 or 16 selects encoded data slice 15 for replication when encoded data slice 15 is associated with a 15th storage slot of the set of primary storage slots and the fifteenth storage slot is associated with storage unit 13, where storage unit 13 (e.g., storage slot 29 of 30) is associated with a storage unit performance level that is less than the storage unit performance goal level.

Having identified the at least one encoded data slice for replication, computing device 12 or 16, for each identified encoded data slice replication, determines a number of redundant slices to produce based on one or more of a desired performance level, a lookup, and a predetermination. For example, computing device 12 or 16 determines to produce three redundant slices for encoded data slice 15 when the desired performance level indicates to produce three redundant slices.

Having determined the number of redundant slices to produce, computing device 12 or 16 replicates the identified encoded data slice to produce the number of redundant slices. For instance, the computing device 12 or 16 replicates encoded data slice 15 to produce three redundant encoded data slices 15.

Having produced the redundant slices (e.g., replicated encoded data slices), for each redundant slice, computing device 12 or 16 selects at least one alternate storage slot. The selecting may be based on one or more of a slice to storage slot mapping, performance levels of the storage units, a storage unit performance threshold level, a performance goal, a network loading level, and a network loading level goal. For example, the computing device 12 or 16 selects storage slots 9, 17, and 30 for storage of the redundant slices when storage slots 9, 17, and 30 are not included in the set of primary storage slots and performance levels of the associated storage units (e.g., storage units 4, 7, and 14) are each greater than the storage unit performance threshold level.

FIG. 9B illustrates further steps of the example of operation of the storing of the data to the storage unit set 82, where the computing device 12 or 16 generates a set of first write slice requests 86 regarding the set of encoded data slices less the identified encoded data slice. As a specific example, computing device 12 or 16 generates one or more sets of write slice requests 86, where the one or more sets of write slice requests 86 includes the set of encoded data slices less encoded data slice 15.

Having generated the set of first write slice requests 86, computing device 12 or 16 sends, via the network 24, the set of first write slice requests 86 to storage units of the storage unit set 82 that correspond to the selected set of primary storage slots. For instance, computing device 12 or 16 sends write slice requests to store encoded data slices 1-2 in storage slots 1-2 of storage unit 1, encoded data slices 3-4 in storage slots 4-5 of storage unit 2, encoded data slice 5 in storage slot 7 of storage unit 3, encoded data slice 6 in storage slot 13 of storage unit 5, encoded data slices 7-9 in storage slots 14-16 of storage unit 6, encoded data slice 10 in storage slot 19 of storage unit 8, encoded data slices 11-12 in storage slots 23-24 of storage unit 10, and encoded data slices 13-14 in storage slots 27-28 of storage unit 12.

Having sent the set of first write requests, computing device 12 or 16 generates a set of second write slice requests 86 regarding the identified encoded data slice. As a specific example, the set of second write slice requests 86 includes the identified encoded data slice and the one or more redundant encoded data slices of the identified encoded data slice. For instance, the set of second write slice requests 86 includes encoded data slice 15, and the three copies of redundant encoded data slice 15.

Having generated the set of second write requests 86, computing device 12 or 16 sends, via the network 24, the set of second write requests to a set of storage units of the DSN, wherein each storage unit of the set of storage units is sent a corresponding one of the set of second write requests. For instance, computing device 12 or 16 sends write slice requests to storage unit 4 to store a first redundant encoded data slice 15 in storage slot 9, sends another write slice request to storage unit 7 to store a second redundant encoded data slice 15 in storage slot 17, sends yet another write slice request to storage unit 14 to store a third redundant encoded data slice 15 in storage slot 30 and sends a further write slice request to storage unit 13 to store encoded data slice 15 (e.g., the identified encoded data slice) in storage slot 29 of storage unit 13.

Alternatively, or in addition to, computing device 12 or 16 may identify a second encoded data slice of the set of encoded data slices for the redundant write operation to produce a second identified encoded data slice. When producing the second encoded data slice, computing device 12 or 16 generates the set of first write requests regarding the set of encoded data slices less the identified encoded data slice and the second identified encoded data slice. Having generated the set of first write requests, computing device 12 or 16 generates a set of third write requests regarding the second identified encoded data slice. For instance, the set of third write requests includes the second identified encoded data slice and one or more replicates of the second identified encoded data slice. Having generated the set of third write requests, computing device 12 or 16 sends, via the network 24, the set of third write requests to a second set of storage units of the DSN, where each storage unit of the second set of storage units is sent a corresponding one of the set of third write requests.

FIG. 9C illustrates further steps of the example of operation of the storing of the data to the storage unit set 82, where computing device 12 or 16 receives, via the network 24, write responses 86 from at least some storage units of a combined set of storage units that includes the storage units and the set of storage units. Each write slice response includes a write operation status indicator. The write operation status indicator includes a favorable indication when a corresponding write slice request was successfully executed. The write operation status indicator includes an unfavorable indication when the corresponding write slice request was not successfully executed (e.g., due to an error).

The receiving of the write slice responses 88 may be associated with varying timing such that individual write slice responses 88 from different storage units are received within different time frames by computing device 12 or 16. For instance, a favorable write slice response 88 may be received from storage unit 4 regarding redundant encoded data slice 15 before receiving another favorable write slice response 88 from storage unit 7 regarding another redundant encoded data slice 15.

FIG. 9D illustrates further steps of the example of operation of the storing of the data to the storage unit set 82, where the computing device 12 or 16, having received the write responses from the at least some storage units of the combined set of storage units that includes the storage units and the set of storage units, issues one or more commands based on the received write responses. As a specific example, computing device 12 or 16 receives a write response 88 from a storage unit of the set of storage units (e.g., a storage unit associated with storage of the identified encoded data slice and the redundant encoded data slices) and sends, via the network 24, a delete write request (e.g., a rollback request 92) to remaining storage units of the set of storage units. For instance, computing device 12 or 16 receives the write response 88 from storage unit 14 with regards to redundant encoded data slice 15 and sends, via the network 24, rollback requests 92 to storage units 4, 7, and 13 to facilitate deletion of redundant encoded data slices 15 and the identified encoded data slice 15.

As another specific group of examples, the computing device 12 or 16 receives, via the network 24, the write responses from the at least some storage units of the combined set of storage units that includes the storage units and the set of storage units and issues the one or more commands based on the received write responses. As a first specific example of the group of examples, the issuing of the one or more commands includes, when a threshold number of write responses (e.g., favorable write threshold number for unique slices) have been received, the computing device 12 or 16 sends, via the network 24, a write commit command (e.g., commit request 90) to each storage unit of the at least some storage units of the combined set of storage units (e.g., send to storage units storing unique slices). For instance, computing device 12 or 16 generates and sends, via the network 24, commit requests 90 to commit storage of encoded data slices 1-2 in storage slots 1-2 of storage unit 1, encoded data slices 3-4 in storage slots 4-5 of storage unit 2, encoded data slice 5 in storage slot 7 of storage unit 3, encoded data slice 6 in storage slot 13 of storage unit 5, encoded data slices 7-9 in storage slots 14-16 of storage unit 6, encoded data slice 10 in storage slot 19 of storage unit 8, encoded data slices 11-12 in storage slots 23-24 of storage unit 10, encoded data slices 13-14 in storage slots 27-28 of storage unit 12, and redundant encoded data slices 15 in storage slots 30 of storage unit 14.

As a second specific example of the group of examples, the issuing of the one or more commands includes computing device 12 or 16 determining whether the at least some storage units of the combined set of storage units include a storage unit of the set of storage units. When the at least some storage units of the combined set of storage units includes the storage unit of the set of storage units, the computing device 12 or 16 sends, via the network 24, a write commit command 90 to the storage unit of the set of storage units and sends, via the network 24, a rollback command 92 to each remaining storage unit of the set of storage units (e.g., to just keep one slice).

As a third specific example of the group of examples, the issuing of the one or more commands includes computing device 12 or 16 determining whether the at least some storage units of the combined set of storage units include the storage unit of the set of storage units. When the at least some storage units of the combined set of storage units does not include the storage unit of the set of storage units, computing device 12 or 16 sends, via the network 24, the rollback command 92 to each storage unit of the set of storage units (e.g., to delete replicate slices and the identified encoded data slice since not needed).

As a fourth specific example of the group of examples, the issuing of the one or more commands includes the computing device 12 or 16 receiving, via the network 24, commit responses from the at least some storage units of the combined set of storage units that includes the storage units and the set of storage units. When a commit threshold number of commit responses have been received, the computing device 12 or 16 sends, via the network 24, a write finalize command to each storage unit of the at least some storage units of the combined set of storage units (e.g., send to units storing unique slices).

As a fifth specific example of the group of examples, the issuing of the one or more commands includes the computing device 12 or 16 determining whether the at least some storage units of the combined set of storage units that provided the commit responses include the storage unit of the set of storage units. When the at least some storage units of the combined set of storage units that provided the commit responses includes the storage unit of the set of storage units, the computing device 12 or 16 sends, via the network 24, a write finalize command to the storage unit of the set of storage units and sends, via the network 24, an undo command to each remaining storage unit of the set of storage units (e.g., to just keep one slice).

As a sixth specific example of the group of examples, the issuing of the one or more commands includes computing device 12 or 16 determining whether the at least some storage units of the combined set of storage units that provided the commit responses include the storage unit of the set of storage units. When the at least some storage units of the combined set of storage units that provided the commit responses units does not include the storage unit of the set of storage units, computing device 12 or 16 sends, via the network 24, an undo command to the set of storage units (e.g., to delete replicate slices and the identified encoded data slice since not needed).

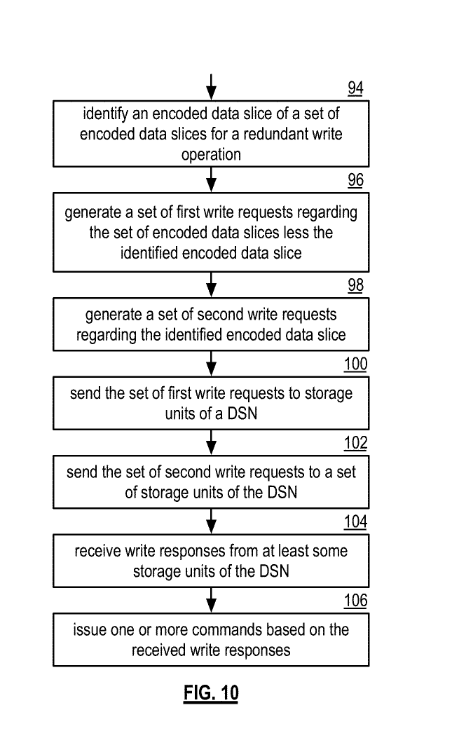

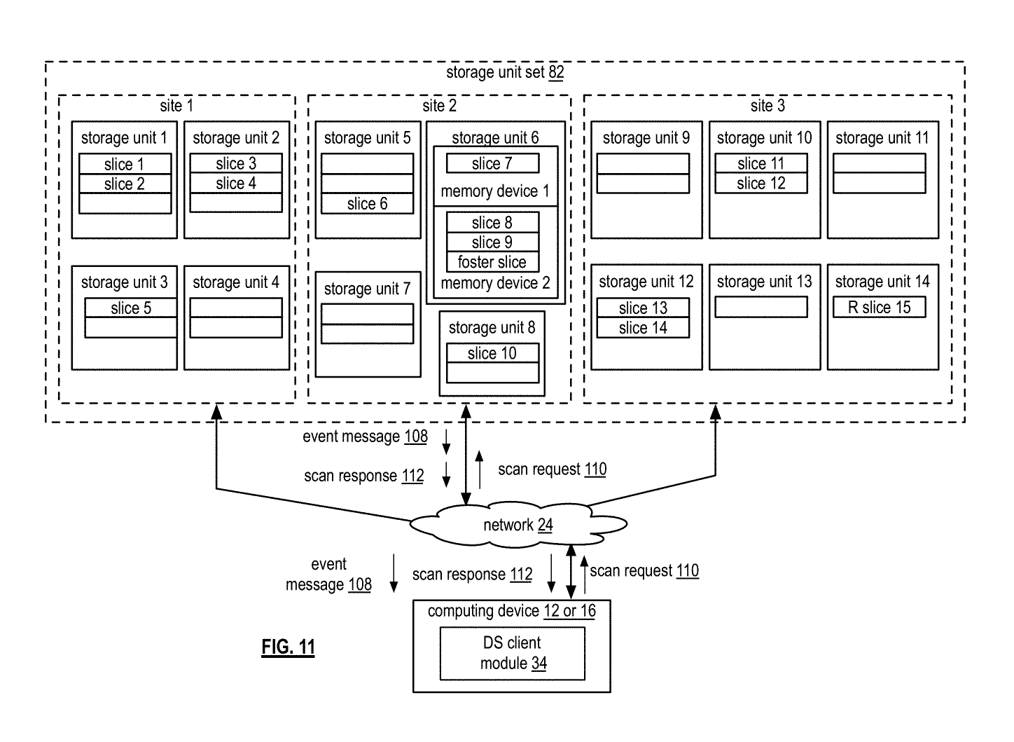

FIG. 10 is a flowchart illustrating an example of storing data. The method begins at step 94 where a processing module of a computing device of one or more computing devices of a dispersed storage network (DSN) identifies an encoded data slice of a set of encoded data slices for a redundant write operation to produce an identified encoded data slice. For example, the processing module identifies an encoded data slice slated for storage to a storage unit associated with an unfavorable storage reliability level.

The method continues at step 96 where the processing module generates a set of first write requests regarding the set of encoded data slices less the identified encoded data slice. The method continues at step 98 where the processing module generates a set of second write requests regarding the identified encoded data slice (e.g., includes the identified encoded data slice and one or more replicates of the identified encoded data slice).

The method continues at step 100 where the processing module sends the set of first write requests to storage units of the DSN. The method continues at step 102 where the processing module sends the set of second write requests to a set of storage units of the DSN, where each storage unit of the set of storage units is sent a corresponding one of the set of second write requests. Alternatively, or in addition to, the processing module may identify a second encoded data slice of the set of encoded data slices for the redundant write operation to produce a second identified encoded data slice. When identifying the second encoded data slice, the processing module generates the set of first write requests regarding the set of encoded data slices less the identified encoded data slice and the second identified encoded data slice. Having generated the set of first write requests, the processing module generates a set of third write requests regarding the second identified encoded data slice (e.g., includes the second identified encoded data slice and one or more replicates of the second identified encoded data slice). Having generated the set of third write requests, the processing module sends the set of third write requests to a second set of storage units of the DSN, where each storage unit of the second set of storage units is sent a corresponding one of the set of third write requests.

The method continues at step 104 where the processing module receives write responses from at least some storage units of a combined set of storage units that includes the storage units and the set of storage units. The method continues at step 106 where the processing module issues one or more commands based on the received write responses. As a specific example, the processing module receives a write response from a storage unit of the set of storage units and sends a delete write request (e.g., a rollback request) to remaining storage units of the set of storage units.

As another specific group of examples, the processing module receives the write responses from the at least some storage units of the combined set of storage units that includes the storage units and the set of storage units and issues the one or more commands based on the received write responses. As a first specific example of the group of examples, the issuing of the one or more commands includes, when a threshold number of write responses (e.g., favorable write threshold number for unique slices) have been received, the processing module sends a write commit command to each storage unit of the at least some storage units of the combined set of storage units (e.g., send to storage units storing unique slices).

As a second specific example of the group of examples, the issuing of the one or more commands includes the processing module determining whether the at least some storage units of the combined set of storage units include a storage unit of the set of storage units. When the at least some storage units of the combined set of storage units includes the storage unit of the set of storage units, the processing module sends a write commit command to the storage unit of the set of storage units and sends a rollback command to each remaining storage unit of the set of storage units (e.g., to just keep one slice).

As a third specific example of the group of examples, the issuing of the one or more commands includes the processing module determining whether the at least some storage units of the combined set of storage units include the storage unit of the set of storage units. When the at least some storage units of the combined set of storage units does not include the storage unit of the set of storage units, the processing module sends the rollback command to each storage unit of the set of storage units (e.g., to delete replicate slices and the identified encoded data slice since not needed).

As a fourth specific example of the group of examples, the issuing of the one or more commands includes the processing module receiving commit responses from the at least some storage units of the combined set of storage units that includes the storage units and the set of storage units. When a commit threshold number of commit responses have been received, the processing module sends a write finalize command to each storage unit of the at least some storage units of the combined set of storage units (e.g., send to units storing unique slices).

As a fifth specific example of the group of examples, the issuing of the one or more commands includes the processing module determining whether the at least some storage units of the combined set of storage units that provided the commit responses include the storage unit of the set of storage units. When the at least some storage units of the combined set of storage units that provided the commit responses includes the storage unit of the set of storage units, the processing module sends a write finalize command to the storage unit of the set of storage units and sends an undo command to each remaining storage unit of the set of storage units (e.g., to just keep one slice).

As a sixth specific example of the group of examples, the issuing of the one or more commands includes the processing module determining whether the at least some storage units of the combined set of storage units that provided the commit responses include the storage unit of the set of storage units. When the at least some storage units of the combined set of storage units that provided the commit responses units does not include the storage unit of the set of storage units, the processing module sends an undo command to the set of storage units (e.g., to delete replicate slices and the identified encoded data slice since not needed).

The method described above in conjunction with the processing module can alternatively be performed by other modules of the dispersed storage network or by other devices. In addition, at least one memory section that stores operational instructions can, when executed by one or more processing modules of one or more computing devices of the dispersed storage network (DSN), cause the one or more computing devices to perform any or all of the method steps described above.

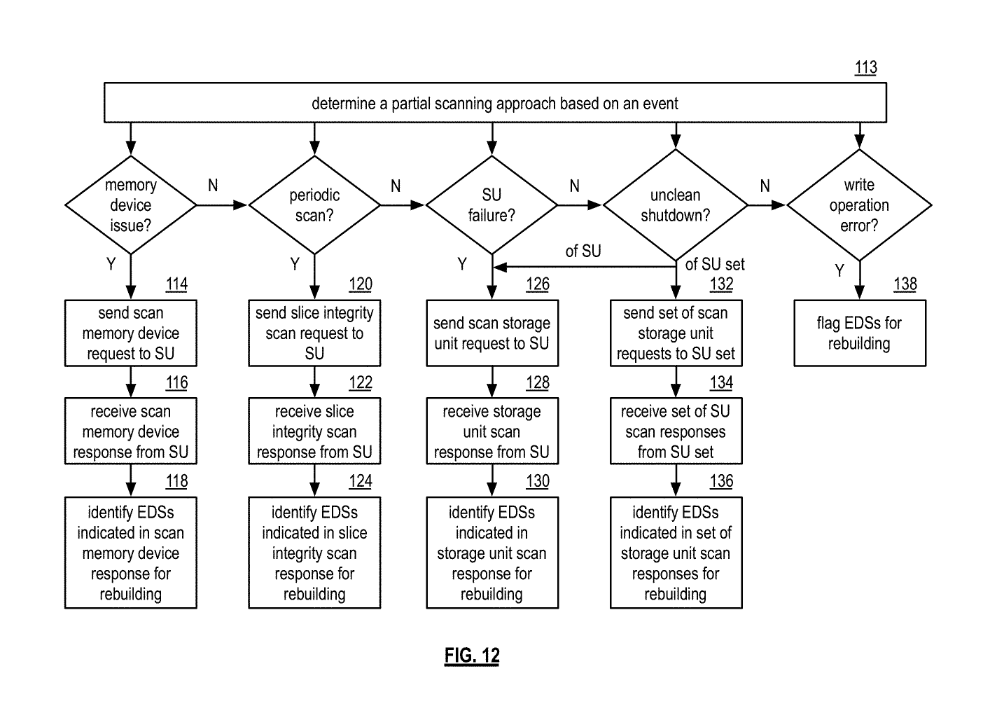

FIG. 11 is a schematic block diagram of another embodiment of a dispersed storage network (DSN) that includes computing device 12 or 16, storage unit set 82, and network 24. Computing device 12 or 16 includes a dispersed storage (DS) client module 34, which enables the computing device to dispersed storage error encode and decode data. Storage unit set 82 includes a set of storage units 36, where one or more storage units are deployed at one or more sites. Each storage unit provides at least one storage slot of N storage slots. A storage slot includes at least one of a virtual storage location associated with physical memory of the storage where storage units 1-14 include one or more physical memory devices. For example, storage unit 6 includes memory device 1 associated with encoded data slice 7 and memory device 2 associated with encoded data slices 8-9 and foster slice. The storage unit set 82 includes storage units 1-14 where 30 storage slots are provided and a varying number of storage slots are associated with each storage unit. Storage units 1-4 are deployed at site 1, storage units 5-8 are deployed at site 2, and storage units 9-14 are deployed at site 3.

When target widths are employed, a full width number of encoded data slices are written to a full number of storage locations (slots). Here, the pillar width number is 15 such that 15 encoded data slices are always written to 15 storage slots. Target widths eliminate a large class of errors that might otherwise lead to encoded slices needing to be rebuilt. Because encoded data slices are written in all cases, the only encoded data slices that need to be rebuilt are those identified by certain events. An event includes one or more of a memory device issue (e.g., a memory device failure, a memory device error, etc.), a periodic scan (e.g., to perform an integrity check of encoded data slices), a storage unit failure, a write operation error, an unclean shutdown of a storage unit, and an unclean shutdown of the set of storage units. In many cases, encoded data slices in need of rebuilding can be identified in isolation without having to confer with other storage units (e.g., via a partial scan of the storage unit experiencing the event). Full scans therefore need to be run in only very rare cases.

In an example of operation, the computing device 12 or 16 determines an event. Computing device 12 or 16 determines that an event has occurred, detects an event, and/or receives a message regarding an event (e.g., from a storage unit, user computing device, etc.). For example, storage unit 6 sends computing device 12 or 16 an event message 108 indicating that memory device 1 has failed. Computing device 112 or 16 determines a scanning approach based on an event to identify encoded data slices for rebuilding. In this example, based on the memory device failure, computing device 12 or 16 determines a partial scanning approach to include sending a scan request 110 to storage unit 6. Here, the scan request 110 is a scan memory device request to scan memory device 1 for encoded data slices affected by the memory device failure. The scan memory device request is a request to list the slice name range associated with memory device 1 experiencing the memory device issue. In response, the storage unit returns the list of slice names associated with the memory device experiencing the issue. Computing device 12 or 16 receives a scan response 112 (e.g., a scan memory device response in this example) from storage unit 6 indicating that encoded data slice 7 is associated with failed memory device 1 and is in need of rebuilding.

As another example, when the event is a periodic scan of storage unit 6, the partial scanning approach includes sending a scan request 110 that is a slice integrity scan request to storage unit 6. The slice integrity scan request includes a request for storage unit 6 to perform an integrity check on all encoded data slices of a data object it stores. Computing device 12 or 16 receives a slice integrity scan response 112. For example, storage unit 6 sends computing device 12 or 16 a slice integrity scan response indicating that a slice integrity failure has occurred for slice 7 when a calculated integrity value for slice 7 compares unfavorably (e.g., not substantially the same) to a stored integrity value for slice 7. As another example, storage unit 6 indicates that slice 7 is missing when inventory of presently stored slices compares unfavorably to a list of previously stored slices (e.g., slice 7 is missing from the inventory). Therefore, slice 7 requires rebuilding.

As another example, when the event is a failure of storage unit 6, the partial scanning approach includes sending a scan request 110 that is a scan storage unit request to storage unit 6. The scan storage unit request includes a request to scan all slice name ranges including foster slices associated with storage unit 6 (e.g., list all slice names associated with all memory devices of the storage unit). Computing device 12 or 16 receives a scan storage unit scan response 112. For example, the scan storage unit scan response indicates that encoded data slices 7-9 and foster slice are in need of rebuilding.

As another example, when the event is an unclean shutdown of storage unit 6, the partial scanning approach includes sending a scan request 110 that is a scan storage unit request to storage unit 6. The scan storage unit request includes a request to scan all slice name ranges including foster slices associated with storage unit 6 (e.g., list all slice names associated with all memory devices of the storage unit). Alternatively, the scan storage unit request may include a request to list slices names of encoded data slices of operations open within a time frame prior to the unclean shutdown. For example, a write operation involving slice 7 was in process prior to the unclean shutdown whereas slice 8, 9 and foster slice were not involved in an operation. In that example, the scan storage unit response lists slice 7 as an encoded data slice involved in an open operation within a time frame prior to the unclean shutdown. Computing device 12 or 16 receives a scan storage unit scan response 112. For example, the scan storage unit scan response indicates any of encoded data slices 7-9 and foster slice that are in need of rebuilding due to the unclean shutdown.

As another example, when the event is an unclean shutdown of the set of storage units 82, the computing device 12 or 16 selects a full scanning approach that includes sending a set of scan requests 110 to the set of storage units 82. The set of scan storage unit requests include requests to scan all slice name ranges including foster slices associated with the set of storage units 82. Computing device 12 or 16 receives a set of scan storage unit scan responses 112. For example, the set of scan storage unit scan responses indicates any of the encoded data slices 1-15 that are in need of rebuilding due to the unclean shutdown.

As another example, when the event is a write operation error, the computing device 12 or 16 flags encoded data slices for rebuilding based on the write operation error (i.e., no scan is required). Determining the partial scanning approach is further based on one or more of: a performance goal, a performance level, a network loading level, a network loading level goal, interpreting an entry of a system registry, the slice name associated with the event, and a predetermination. For example, when the event is a write operation error and the number of errors is less than an error threshold level, the partial scanning approach may include scanning all the slices of the associated data object.

FIG. 12 is a logic diagram of an example of a method of identifying encoded data slices for rebuilding. The method begins with step 113 where a computing device of a dispersed storage network (DSN) determines an event, where the event is one of a plurality of possible events. For example, an event includes one or more of a memory device issue (e.g., a memory device failure, a memory device error, etc.), a periodic scan (e.g., to perform an integrity check of encoded data slices), a storage unit failure, a write operation error, an unclean shutdown of a storage unit, and an unclean shutdown of the set of storage units. The computing device determines a partial scanning approach based on the event to identify encoded data slices for rebuilding.

When the event is a memory device issue of a memory device of a storage unit of a set of storage units of the DSN, the computing device selects a first partial scanning approach illustrated in steps 114-118. Step 114 includes sending a scan memory device request to the storage unit (SU) to scan the memory device for encoded data slices affected by the memory device issue. The scan memory device request is a request to scan the slice name range associated with the memory device experiencing the memory device issue. The method continues with step 116 where the computing device receives a scan memory device response from the storage unit. The method continues with step 118 where the computing device identifies the encoded data slices (EDSs) indicated in the scan memory device response for rebuilding.

When the event is a periodic scan of a storage unit of the set of storage units, the computing device selects a second partial scanning approach illustrated in steps 120-124. Step 120 that includes sending a slice integrity scan request to the storage unit (SU). The slice integrity scan request includes a request for the storage unit to perform an integrity check on all encoded data slices of a data object it stores. The method continues with step 122 where the computing device receives a slice integrity scan response from the storage unit. A slice integrity scan response may indicate that a slice integrity failure has occurred for an encoded data slice when a calculated integrity value for the encoded data slice compares unfavorably (e.g., not substantially the same) to a stored integrity value for encoded data slice. As another example, the storage unit indicates that an encoded data slice is missing when inventory of presently stored slices compares unfavorably to a list of previously stored slices (e.g., the encoded data slice is missing from the inventory). The method continues with step 124 where the computing device identifies encoded data slices (EDSs) indicated in the slice integrity scan response for rebuilding.

When the event is a failure of a storage unit of the set of storage units, the computing device selects a third partial scanning approach illustrated in steps 126-130. Step 126 includes sending a scan storage unit request to the failed storage unit (SU). The scan storage unit request includes a request to scan all slice name ranges including foster slices associated with storage unit. The method continues with step 128 where the computing device receives a scan storage unit scan response from the failed storage unit. The method continues with step 130 where the computing device identifies encoded data slices (EDSs) indicated in the scan storage unit response for rebuilding.

When the event is an unclean shutdown of a storage unit of the set of storage units, the method branches to steps 126-130. However, the scan storage unit request of step 126 may alternatively include a request to list slices names of encoded data slices of operations open within a time frame prior to the unclean shutdown. When the event is an unclean shutdown of the set of storage units, the computing device selects a full scanning approach illustrated in steps 132-136. Step 132 includes sending a set of scan storage unit requests to the set of storage units (SUs). The set of scan storage unit requests include requests to scan all slice name ranges including foster slices associated with the set of storage units. The method continues with step 134 where the computing device receives a set of scan storage unit (SU) responses from the set of storage units. The method continues with step 136 where the computing device identifies encoded data slices (EDSs) indicated in the set of scan storage unit responses for rebuilding.

When the event is a write operation error, the method continues with step 138 where the computing device flags encoded data slices (EDSs) for rebuilding based on the write operation error (i.e., no scan is required). Determining the partial scanning approach is further based on one or more of: a performance goal, a performance level, a network loading level, a network loading level goal, interpreting an entry of a system registry, the slice name associated with the event, and a predetermination. For example, when the event is a write operation error and the number of errors is less than an error threshold level, the partial scanning approach may include scanning all the slices of the associated data object.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provides an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

While the transistors in the above described figure(s) is/are shown as field effect transistors (FETs), as one of ordinary skill in the art will appreciate, the transistors may be implemented using any type of transistor structure including, but not limited to, bipolar, metal oxide semiconductor field effect transistors (MOSFET), N-well transistors, P-well transistors, enhancement mode, depletion mode, and zero voltage threshold (VT) transistors.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid-state memory, a hard drive memory, cloud memory, thumb drive, server memory, computing device memory, and/or other physical medium for storing digital information.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for identifying encoded data slices for rebuilding, the method comprises:
determining, by a computing device of a dispersed storage network (DSN), an event, wherein the event is one of a plurality of possible events;
determining, by the computing device, a partial scanning approach based on the event;
when the event is a memory device issue of a memory device of a storage unit of a set of storage units of the DSN, selecting, by the computing device, a first partial scanning approach that includes:
sending, by the computing device, a scan memory device request to the storage unit to scan the memory device for encoded data slices affected by the memory device issue, wherein the scan memory device request includes a request to list slice names of encoded data slices stored in the memory device;
receiving, by the computing device, a scan memory device response from the storage unit; and
identifying, by the computing device, the encoded data slices indicated in the scan memory device response for rebuilding.

2. The method of claim 1 further comprises:
when the event is a periodic scan of a storage unit of the set of storage units, selecting, by the computing device, a second partial scanning approach that includes:
sending, by the computing device, a slice integrity scan request to the storage unit;
receiving, by the computing device, a slice integrity scan response from the storage unit; and
identifying, by the computing device, encoded data slices indicated in the slice integrity scan response for rebuilding.

3. The method of claim 1 further comprises:
when the event is a storage unit failure, selecting, by the computing device, a third partial scanning approach that includes:
sending, by the computing device, a scan storage unit request to the failed storage unit;
receiving, by the computing device, a scan storage unit response from the failed storage unit; and
identifying, by the computing device, encoded data slices indicated in the scan storage unit response for rebuilding.

4. The method of claim 1 further comprises:
when the event is a write operation error, selecting, by the computing device, a fourth partial scanning approach that includes:
flagging, by the computing device, encoded data slices for rebuilding based on the write operation error.

5. The method of claim 1 further comprises:
when the event is an unclean shutdown of a storage unit of the set of storage units, selecting, by the computing device, a fifth partial scanning approach that includes:
sending, by the computing device, a scan storage unit request to the storage unit, wherein the scan storage unit request includes one of:
a request to list slices names of encoded data slices stored across memory devices of the storage unit; and
a request to list slices names of encoded data slices of operations open within a time frame prior to the unclean shutdown; and
receiving, by the computing device, a scan storage unit response from the storage unit; and
identifying, by the computing device, encoded data slices indicated in the scan storage unit response for rebuilding.

6. The method of claim 1 further comprises:
when the event is an unclean shutdown of the set of storage units, selecting, by the computing device, a full scanning approach that includes:
sending, by the computing device, a set of scan storage unit requests to the set of storage units;
receiving, by the computing device, a set of scan storage unit responses from the set of storage units; and
identifying, by the computing device, encoded data slices indicated in the set of scan storage unit responses for rebuilding.

7. The method of claim 1, wherein the determining the partial scanning approach is further based on one or more of: a performance goal, a performance level, a network loading level, a network loading level goal, interpreting an entry of a system registry, the slice name associated with the event, and a predetermination.

8. A computing device of a dispersed storage network (DSN), the computing device comprises:
an interface;
memory; and
a processing module operably coupled to the memory and the interface, wherein the processing module is operable to identify encoded data slices for rebuilding by:
determining an event, wherein the event is one of a plurality of possible events;
determining a partial scanning approach based on the event;
when the event is a memory device issue of a memory device of a storage unit of a set of storage units of the DSN, selecting a first partial scanning approach that includes:
sending a scan memory device request to the storage unit to scan the memory device for encoded data slices affected by the memory device issue, wherein the scan memory device request includes a request to list slice names of encoded data slices stored in the memory device;
receiving a scan memory device response from the storage unit; and
identifying the encoded data slices indicated in the scan memory device response for rebuilding.

9. The computing device of claim 8, wherein the processing module is further operable to:
when the event is a periodic scan of a storage unit of the set of storage units, select a second partial scanning approach that includes:
send a slice integrity scan request to the storage unit;
receive a slice integrity scan response from the storage unit; and
identify encoded data slices indicated in the slice integrity scan response for rebuilding.

10. The computing device of claim 8, wherein the processing module is further operable to:
when the event is a storage unit failure, select a third partial scanning approach that includes:
sending a scan storage unit request to the failed storage unit;
receiving a scan storage unit response from the failed storage unit; and
identifying encoded data slices indicated in the scan storage unit response for rebuilding.

11. The computing device of claim 8, wherein the processing module is further operable to:
when the event is a write operation error, select a fourth partial scanning approach that includes:
flagging encoded data slices for rebuilding based on the write operation error.

12. The computing device of claim 8, wherein the processing module is further operable to:
when the event is an unclean shutdown of a storage unit of the set of storage units, select a fifth partial scanning approach that includes:
sending a scan storage unit request to the storage unit, wherein the scan storage unit request includes one of:
a request to list slices names of encoded data slices stored across memory devices of the storage unit; and
a request to list slices names of encoded data slices of operations open within a time frame prior to the unclean shutdown; and
receiving a scan storage unit response from the storage unit; and
identifying encoded data slices indicated in the scan storage unit response for rebuilding.

13. The computing device of claim 8, wherein the processing module is further operable to:
when the event is an unclean shutdown of the set of storage units, select a full scanning approach that includes:
sending a set of scan storage unit requests to the set of storage units;
receiving a set of scan storage unit responses from the set of storage units; and
identifying encoded data slices indicated in the set of scan storage unit responses for rebuilding.

14. The computing device of claim 8, wherein the determining the partial scanning approach is further based on one or more of: a performance goal, a performance level, a network loading level, a network loading level goal, interpreting an entry of a system registry, the slice name associated with the event, and a predetermination.
